(19) United States
(12) Patent Application Publication
(10) Pub. No.: US 2004/0017936 A1
(43) Pub. Date: Jan. 29, 2004

(54) Method, system and computer product for calculating mass scores

(76) Inventors: Priya Gopinath, Waukesha, WI (US); Kishore Acharya, Brookfield, WI (US); Jianying Li, New Berlin, WI (US)

Correspondence Address: CANTOR COLBURN, LLP, 55 GRIFFIN ROAD SOUTH, BLOOMFIELD, CT, 06002

(21) Appl. No.: 10/064,566

(22) Filed: Jul. 26, 2002

(51) Int. Cl. G06K 9/00

(52) U.S. Cl. 382/131

(57) ABSTRACT

A method for calculating mass scores of calcium deposits. The method includes obtaining patient image data and identifying calcium plaque in the patient image data. The calcium plaque is associated with a plurality of discrete patient pixel elements and each of the patient pixel elements includes a patient pixel value expressed in Hounsfield units. The method also includes converting the patient pixel values into patient density values using a calibration curve equation and outputting the patient density values.

### BACKGROUND OF INVENTION

The present disclosure relates generally to a method for calculating mass scores and in particular, to a method for calculating mass scores of calcium deposits that accounts for beam hardening.

In at least one known computed tomography (CT) imaging system configuration, an x-ray source projects a fan-shaped beam which is collimated to lie within an X-Y plane of a Cartesian coordinate system, wherein the X-Y plane is generally referred to as an “imaging plane”. An array of radiation detectors, wherein each radiation detector includes a detector element, is within the CT system so as to receive this fan-shaped beam. An object, such as a patient, is disposed within the imaging plane so as to be subjected to the x-ray beam wherein the x-ray beam passes through the object. As the x-ray beam passes through the object being imaged, the x-ray beam becomes attenuated before impinging upon the array of radiation detectors. The intensity of the attenuated beam radiation received at the detector array is responsive to the attenuation of the x-ray beam by the object, wherein each detector element produces a separate electrical signal responsive to the beam attenuation at the detector element location. These electrical signals are referred to as x-ray attenuation measurements.

In addition, the x-ray source and the detector array may be rotated, with a gantry within the imaging plane, around the object to be imaged so that the angle at which the x-ray beam intersects the object constantly changes. A group of x-ray attenuation measurements, i.e., projection data, from the detector array at one gantry angle is referred to as a “view”. A “scan” of the object comprises a set of views made at different gantry angles during one revolution of the x-ray source and the detector array. In an axial scan, the projection data is processed so as to construct an image that corresponds to a two-dimensional slice taken through the object.

One method for reconstructing an image from a set of projection data is referred to as the “filtered back-projection technique”. This process converts the attenuation measurements from a scan into discrete integers, ranging from −2047 to +2047, called “Hounsfield Units” (HU) or CT HUs. These CT HU's are used to control the brightness of a corresponding pixel on a cathode ray tube or a computer screen display in a manner responsive to the attenuation measurements. For example, an attenuation measurement for air may convert into an integer value of −2047 HU's (corresponding to a dark pixel) and an attenuation measurement for very dense bone matter may convert into an integer value of +2000 HUs (corresponding to a bright pixel), whereas an attenuation measurement for water may convert into an integer value of 0 HU's (corresponding to a gray pixel). This integer conversion, or “scoring” allows a physician or a technician to determine the density of matter based on the intensity of the computer display.

One measure of heart disease is the quantity of calcium in the coronary vessels of the heart. When a patient undergoes a CT scan of the heart, a radiologist or technician can view the resulting images and identify the calcium plaque in the heart along with the name of the vessels containing the calcium. The amount of calcium located in the heart can be totaled, resulting in a total calcium score that can be compared to other patients of the same age and characteristics. This gives the patient and his health care providers one way to measure whether the patient is worse off or better off than others of like age and characteristics. The calcium plaque is associated with a plurality of discrete pixel elements which include pixel values expressed in HUs. There are three scores which can quantify the plaque. The Agatson Janovitz (AJ) score is the most popular score among radiologists assessing cardiac images and is widely used by all vendors offering coronary calcium scoring packages. However, it is also the most susceptible to noise as its computation involves the area and the maximum pixel CT HU in the plaque area. The second score, called the volume score, is used by research radiologists and is more reproducible than the AJ score. However, it is also limited in accuracy by the limitations on slice thickness and voxel dimensions. The third score, the mass score, is the most accurate of the three scores because it accounts for linear partial volume effect and uses the mean CT HU which corrects with changes in slice thickness. The calcium plaque mass total calculated from a CT image is expressed today in terms of CT HUs, which provides a number that patients and healthcare providers may not understand. The mass score can be converted into a density expressed in milligrams in order to aid in patient and healthcare provider understanding.

One way to convert the CT HUs into density, expressed as milligrams, is to place a phantom with calcium inserts of known densities underneath the patient during the same CT scan operation that is used to locate calcium deposits in the patient's coronary vessels. The idea of placing the phantom below the patient is to get the closest xray beam attenuation for the size of the patient. Then, the density values of the calcium inserts, expressed in milligrams, can be used to translate the CT HUs into milligram values. Thus, the calcium deposits located in the patient's coronary vessels can be converted into a density expressed in milligrams taking into account the size of the patient and his/her attenuating characteristics. Placing a phantom with calcium inserts of known densities under each patient can aid in providing more accuracy in converting CT HUs into a calcium mass expressed as milligrams. However, this approach can increase the workload of the operator, can be uncomfortable for the patient and can add to the expense of the scanning process by requiring that a phantom with calcium inserts of known densities be available at each image station. Another disadvantage of using this option is that although the beam attenuation is more customized to differently sized patients, the phantom is placed below the patient while the correction is aimed at the heart through which xrays pass first, so it is not a true correction.

### SUMMARY OF INVENTION

One aspect of the invention is a method for calculating mass scores of calcium deposits. The method includes obtaining patient image data and identifying calcium plaque in the patient image data. The calcium plaque is associated with a plurality of discrete patient pixel elements and each of the patient pixel elements includes a patient pixel value expressed in Hounsfield units. The method also includes converting the patient pixel values into patient density values using a calibration curve equation and outputting the patient density values.

Another aspect of the invention is a method for calculating mass scores of calcium deposits. The method comprises creating a calibration curve equation. The creating includes obtaining phantom image data associated with a plurality of discrete phantom pixels corresponding to a calcium insert of known density in a phantom, wherein each of the phantom pixel elements includes a phantom pixel value expressed in Hounsfield units. The creating also includes graphing the phantom image data against the known density of the calcium insert and developing the calibration curve equation for computing the patient density values in response to the patient pixel values. The method for calculating mass scores of calcium deposits also comprises obtaining patient image data and identifying calcium plaque in the patient image data. The calcium plaque is associated with a plurality of discrete patient pixel elements and each of the patient pixel elements includes a patient pixel value expressed in Hounsfield units. The method for calculating mass scores of calcium deposits also comprises converting the patient pixel values into patient density values using a calibration curve equation and outputting the patient density values.

Another aspect of the invention is a system for calculating mass scores of calcium deposits. The system comprises an imaging system and an object disposed so as to be communicated with the imaging system, wherein the imaging system generates image data responsive to the object. The system also comprises a processing device in communication with the imaging system including software to implement a method comprising obtaining image data and identifying calcium plaque in the image data. The calcium plaque is associated with a plurality of discrete pixel elements and each of the pixel elements includes a pixel value expressed in Hounsfield units. The method also comprises converting the pixel values into density values using a calibration curve equation and outputting the density values.

A further aspect of the invention is a computer program product for calculating mass scores of calcium deposits. The computer program product includes a storage medium readable by a processing circuit and storing instructions for execution by the processing circuit for obtaining patient image data and identifying calcium plaque in the patient image data. The calcium plaque is associated with a plurality of discrete patient pixel elements and each of the patient pixel elements includes a patient pixel value expressed in Hounsfield units. The method also includes converting the patient pixel values into patient density values using a calibration curve equation and outputting the patient density values.

A further aspect of the invention is a computer program product for calculating mass scores of calcium deposits. The computer program product includes a storage medium readable by a processing circuit and storing instructions for execution by the processing circuit including instructions to create a calibration curve equation. The creating includes obtaining phantom image data associated with a plurality of discrete phantom pixels corresponding to a calcium insert of known density in a phantom, wherein each of the phantom pixel elements includes a phantom pixel value expressed in Hounsfield units. The creating also includes graphing the phantom image data against the known density of the calcium insert and developing the calibration curve equation for computing the patient density values in response to the patient pixel values. The storage medium also includes instructions for calculating mass scores of calcium deposits also comprises obtaining patient image data and identifying calcium plaque in the patient image data. The calcium plaque is associated with a plurality of discrete patient pixel elements and each of the patient pixel elements includes a patient pixel value expressed in Hounsfield units. The storage medium also includes instructions for converting the patient pixel values into patient density values using a calibration curve equation and outputting the patient density values.

Further aspects of the invention are disclosed herein. The above discussed and other features and advantages of the present invention will be appreciated and understood by those skilled in the art from the following detailed description and drawings.

### BRIEF DESCRIPTION OF DRAWINGS

Referring to the exemplary drawings wherein like elements are numbered alike in the several FIGURES:

FIG. 1 is a perspective view of a CT imaging system and a patient disposed for imaging in accordance with an exemplary embodiment;

FIG. 2 is a block schematic diagram of a CT imaging system in accordance with an exemplary embodiment;

FIG. 3 is an exemplary apparatus for use in developing the calibration curve equation;

FIG. 4 is a block diagram of an exemplary process for developing a calibration curve equation that accounts for beam hardening; and

FIG. 5 is a block diagram of an exemplary process for computing calcium deposit density in milligrams.

### DETAILED DESCRIPTION

In one embodiment of the present invention, one set of calibration curves is created using a dummy medium sized body phantom on top of the calibration phantom. This set of calibration curves is applied to all patients. In another embodiment, a human chest like phantom with known calibration inserts in the area of the heart is utilized to create a single set of calibration curves. Immaterial of the type of phantom and technique used, an embodiment of the invention is the usage of a single set of calibration curves for the computation of mass score for all patients. In accordance with an exemplary embodiment of the present invention, while a method, system and computer product for calculating mass scores is described hereinbelow with reference to a computed tomography (CT) system, it should be understood that the method, system and computer product of the present invention may be applied to other imaging systems, such as magnetic resonance imaging (MRI).

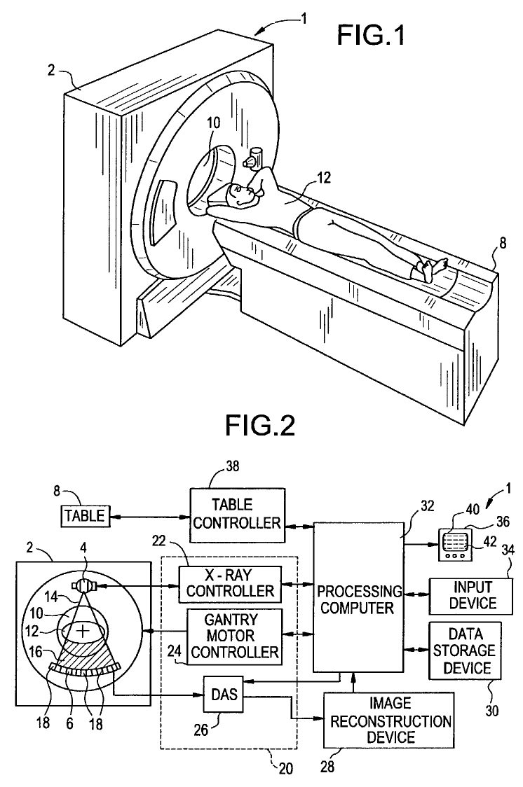

Referring to FIG. 1 and FIG. 2, a representative CT imaging system 1 is shown, including a gantry 2 having an x-ray source 4, a radiation detector array 6, a patient support structure 8 and a patient cavity 10, wherein the x-ray source 4 and the radiation detector array 6 are opposingly disposed so as to be separated by the patient cavity 10. In an exemplary embodiment, a patient 12 is disposed upon the patient support structure 8 which is then disposed within the patient cavity 10. The x-ray source 4 projects an x-ray beam 14 toward the radiation detector array 6 so as to pass through the patient 12. In an exemplary embodiment, the x-ray beam 6 is collimated by a collimate (not shown) so as to lie within an X-Y plane of a Cartesian coordinate system referred to as an “imaging plane”. After passing through and becoming attenuated by the patient 12, the attenuated x-ray beam 16 is received by the radiation detector array 6. In an exemplary embodiment, the radiation detector array 6 includes a plurality of detector elements 18 wherein each of said detector elements 18 receives an attenuated x-ray beam 16 and produces an electrical signal responsive to the intensity of the attenuated x-ray beam 16.

In addition, in an exemplary embodiment, the x-ray source 4 and the radiation detector array 6 are rotatingly disposed relative to the gantry 2 and the patient support structure 8, so as to allow the x-ray source 4 and the radiation detector array 6 to rotate around the patient support structure 8 when the patient support structure 8 is disposed within the patient cavity 10. X-ray projection data is obtained by rotating the x-ray source 4 and the radiation detector array 6 around the patient 12 during a scan. In an exemplary embodiment, the x-ray source 4 and the radiation detector array 6 communicate with a control mechanism 20 associated with the CT imaging system 1. In an exemplary embodiment, the control mechanism 20 controls the rotation and operation of the x-ray source 4 and the radiation detector array 6.

In an exemplary embodiment, the control mechanism 20 includes an x-ray controller 22 communicating with a x-ray source 4, a gantry motor controller 24, and a data acquisition system (DAS) 26 communicating with a radiation detector array 6. The x-ray controller 22 provides power and timing signals to the x-ray source 4, the gantry motor controller 24 controls the rotational speed and angular position of the x-ray source 4, and the radiation detector array 6 and the DAS 26 receive the electrical signal data produced by detector elements 18 and convert this data into digital signals for subsequent processing. In an exemplary embodiment, the CT imaging system 1 also includes an image reconstruction device 28, a data storage device 30 and a processing device 32, wherein the processing device 32 communicates with the image reconstruction device 28, the gantry motor controller 24, the x-ray controller 22, the data storage device 30, an input device 34 and an output device 36. The CT imaging system 1 can also include a table controller 38 in communication with the processing device 32 and the patient support structure 8, so as to control the position of the patient support structure 8 relative to the patient cavity 10.

In accordance with an exemplary embodiment, the patient 12 is disposed on the patient support structure 8, which is then positioned by an operator via the processing device 32 so as to be disposed within the patient cavity 10. The gantry motor controller 24 is operated via processing device 32 so as to cause the x-ray source 4 and the radiation detector array 6 to rotate relative to the patient 12. The x-ray controller 22 is operated via the processing device 32 so as to cause the x-ray source 4 to emit and project a collimated x-ray beam 14 toward the radiation detector array 6 and hence toward the patient 12. The x-ray beam 14 passes through the patient 12 so as to create an attenuated x-ray beam 16, which is received by the radiation detector array 6.

The detector elements 18 receive the attenuated x-ray beam 16, produce electrical signal data responsive to the intensity of the attenuated x-ray beam 16 and communicate this electrical signal data to the DAS 26. The DAS 26 then converts this electrical signal data to digital signals and communicates both the digital signals and the electrical signal data to the image reconstruction device 28, which performs high-speed image reconstruction. This information is then communicated to the processing device 32, which stores the image in the data storage device 30 and displays the digital signal as an image via output device 36. In accordance with an exemplary embodiment, the output device 36 includes a display screen 40 having a plurality of discrete pixel elements 42.

Determining the mass scores of calcium in the coronary vessels requires the use of density of the calcium plaque. This value is indirectly known through the CT HU of the calcium plaque. However, in order to convert CT HUs into density values, a prior curve with a known relationship between known calcium densities and corresponding CT HU values needs to, be computed. The effect of beam hardening should be incorporated into the computation of the calibration curve. Beam hardening is the attenuation of x-rays through the human body until the organ of interest comes in the path of the x-ray beam. If the calibration process does not account for beam hardening, then an inaccuracy would be introduced in the calculation of the density and thus the mass score.

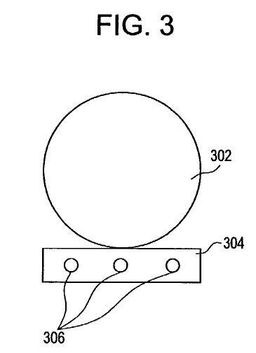

FIG. 3 is an exemplary apparatus for use in developing the calibration curve equation. FIG. 3 depicts a bone mineral density (BMD) phantom 304 that includes three calcium inserts 306 of known densities. In addition, a poly phantom 302 is utilized to mimic the body of a patient in attenuating x-rays through it before the calcium inserts 306 are intercepted in the path of the x-ray beam. In an exemplary embodiment, the calcium inserts 306 are of fixed densities: 50, 100 and 200 milligrams per cubic centimeter. In addition, the background of the BMD phantom 304 is of a known fixed density. Different sized poly phantoms 302 can be used to simulate different sized patients. For example, a 35 centimeter poly phantom 302 could be used to simulate a medium sized patient and a 48 centimeter poly phantom 302 could be used to simulate a large sized patient.

A variety of phantoms are commercially available and can be used in an embodiment of the present invention. The BMD phantom 304 can include any number of calcium inserts; the BMD phantom 304 and the poly phantom 302 can be combined in one physical phantom; and the phantoms 302 304 can be of a variety of sizes and shapes. For example, a BMD phantom 304 containing solid calcium hydroxyapatite samples of known density along with a poly phantom 302 for simulating the body of a patient can be purchased (e.g., the Quantitative CT—Torso Phantom or the Bone Mineral Calibration Phantom from Image Analysis, Inc.) and utilized with an embodiment of the present invention. The BMD phantom 304 would be placed under the poly phantom 302 as depicted in FIG. 3 and then the phantoms 302 304 would be scanned in a CT imaging system to calculate the CT HU values of the calcium inserts of known densities. In another exemplary embodiment, an anthropomorphic cardiac phantom body with calibration inserts (e.g., the Anthropomorphic Cardio Phantom sold by Quality Assurance in Radiology and Medicine) can be utilized. The anthropomorphic phantom body contains material to simulate lungs, a spine and a heart. The calibration insert is contained in the heart portion of the phantom and can contain several cylindrical calcifications that vary in size and density. The plastics used in the anthropomorphic phantom can mimic the tissues in the thorax with respect to density and attenuation characteristics. The anthropomorphic phantom is scanned into the CT imaging system to calculate the CT HU values of the calcium inserts of known densities.

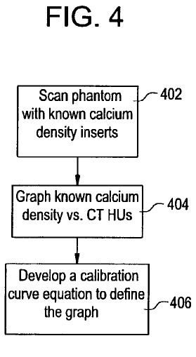

In an exemplary embodiment, phantoms are used to develop a single calibration curve set that can then be used universally for the conversion computation. FIG. 4 is a block diagram of an exemplary process for developing a calibration curve equation that accounts for beam hardening. At step 402, a phantom with known calcium density inserts is scanned in a CT imaging system to create phantom image data. At step 404, the known calcium densities of the calcium inserts and the corresponding phantom CT HUs are graphed. The calibration process involves determining the phantom CT HU for each of the calcium inserts and, at step 406, creating a calibration curve with the known densities. The calibration curve can then be used as a standard curve, which could be used in the conversion of patient CT HUs into patient calcium plaque density. In an exemplary embodiment, the process depicted in FIG. 4 is performed with software located in the processing device 32. In another exemplary embodiment, the process is performed by software located on a computer system remote from the processing device 32. To improve the accuracy of the calibration process different calibration curve sets can be developed. For example, different sized poly phantoms 302 can be used to create different calibration curves that will be used depending on the size of the patient. In another exemplary embodiment, a calibration curve set can be developed to incorporate differences such as the variations due to different scan parameters and the CT number drifts due to aging of the system. The calibration process will set a range within which the above CT HU variations can be tolerated and a mechanism can be set up to alert the technologist if the CT HUs are outside of the bounds.

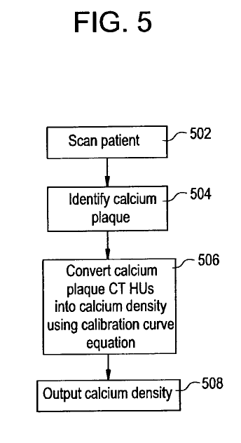

FIG. 5 is a block diagram of an exemplary process for computing calcium plaque density in milligrams. At step 502, a patient is scanned in a CT imaging system such as the one depicted in FIGS. 1 and 2. Next, at step 504, the calcium plaque in the patient's coronary vessels is identified. In an exemplary embodiment, the technologist goes through the series of cardiac images and manually clicks on calcium plaques. The patient pixels that satisfy a preselected threshold criteria (e.g. 130 HUs) and preselected connectivity criteria get highlighted automatically. The software can also provide the option to propagate the selection through all the slices. At step 506, a calibration curve is applied to convert the patient calcium plaque expressed in CT HUs into calcium density expressed in milligrams per cubic centimeter. In an exemplary embodiment, the calibration curve applied in step 506 is derived as described in reference to FIG. 4. In an exemplary embodiment, the conversion at step 506 is performed by software located on the processing device 32. In an alternate exemplary embodiment, the conversion is performed by software located on a computer system remote from the processing device 32. Communication of data between the processing device 32 and the computer system could be through a direct connection or through a network such as an intranet or the Internet. At step 508, the patient calcium plaque, converted into a density expressed as milligrams per cubic centimeters, is output.

An embodiment of the present invention allows a single set of pre-computed calibration curves to be utilized to convert from calcium deposits expressed as CT HUs into a density expressed as milligrams. This can result in decreased workflow and a reduction of CT scan operator errors because the operator is no longer required to look for the known calcium inserts for each patient. In addition, the ability to use a pre-computed set of calibration curves can reduce the implementation cost of converting calcium deposits from CT HUs into density expressed as milligrams because a BMD phantom does not need to be available on each CT scanner where conversion is required. Another benefit to an exemplary embodiment of the present invention is that the CT variations are constantly monitored to comply with the acceptable range which can lead to increased accuracy.

Although the preceding embodiments are discussed with respect to medical imaging, it is understood that the image acquisition and processing methodology described herein is not limited to medical applications, but may be utilized in non-medical applications.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for calculating mass scores of calcium deposits, the method comprising:
obtaining patient image data;
identifying calcium plaque in said patient image data, wherein said calcium plaque is associated with a plurality of discrete patient pixel elements and wherein each of said patient pixel elements includes a patient pixel value expressed in Hounsfield units;
converting said patient pixel values into patient density values using a calibration curve equation; and
outputting said patient density values.

2. The method of claim 1 wherein said obtaining patient image data includes obtaining patient image data using a computed tomography imaging system.

3. The method of claim 1 further comprising:
summing said patient density values resulting in a total mass score; and
outputting said total mass score.

4. The method of claim 3 wherein said total mass score includes said patient density values for one vessel within a heart.

5. The method of claim 3 wherein said total mass score includes said patient density values for all vessels within a heart.

6. The method of claim 1 wherein said identifying includes:
manually selecting said discrete patient pixel elements containing calcium plaque; and
highlighting said patient pixel elements that meet a preselected threshold criteria and a preselected connectivity criteria.

7. The method of claim 6 wherein said preselected threshold criteria includes patient pixel elements with patient pixel values measuring 130 Hounsfield units or greater.

8. The method of claim 1 wherein said calibration curve equation is precomputed.

9. The method of claim 1 further comprising precomputing said calibration curve equation, wherein said precomputing includes:
obtaining phantom image data associated with a plurality of discrete phantom pixel elements corresponding to a calcium insert of known density in a phantom, wherein each of said phantom pixel elements includes a phantom pixel value expressed in Hounsfield units;
graphing said phantom image data against said known density of said calcium insert; and
developing said calibration curve equation for computing said patient density values in response to said patient pixel values.

10. The method of claim 9 wherein said phantom includes a poly phantom and a calibration phantom.

11. The method of claim 10 wherein said poly phantom approximates a medium sized patient.

12. The method of claim 10 wherein said poly phantom approximates a large sized patient.

13. The method of claim 10 wherein said calibration phantom includes three calcium inserts of known density.

14. The method of claim 13 wherein said calcium inserts of known density are 50, 100 and 200 milligrams per cubic centimeter.

15. The method of claim 9 wherein said phantom is an anthropomorphic cardiac phantom body including calcium inserts of known density.

16. A method for calculating mass scores of calcium deposits, the method comprising:
creating a calibration curve equation, wherein said creating includes:
obtaining phantom image data associated with a plurality of discrete phantom pixel elements corresponding to a calcium insert of known density in a phantom, wherein each of said phantom pixel elements includes a phantom pixel value expressed in Hounsfield units;
graphing said phantom image data against said known density of said calcium insert; and
developing said calibration curve equation for computing said patient density values in response to patient pixel values;
obtaining patient image data;
identifying calcium plaque in said patient image data, wherein said calcium plaque is associated with a plurality of discrete patient pixel elements and wherein each of said patient pixel elements includes a said patient pixel value expressed in Hounsfield units;
converting said patient pixel values into patient density values using said calibration curve equation; and
outputting said patient density values.

17. A system for calculating mass scores of calcium deposits, the system comprising:
an imaging system;
an object disposed so as to be communicated with said imaging system, wherein said imaging system generates image data responsive to said object; and
a processing device in communication with said imaging system including software to implement the method comprising:
obtaining said image data;
identifying calcium plaque in said image data, wherein said calcium plaque is associated with a plurality of discrete pixel elements and wherein each of said pixel elements includes a pixel value expressed in Hounsfield units;
converting said pixel values into density values using a calibration curve equation; and
outputting said density values.

18. The system of claim 17 wherein said object is a patient.

19. The system of claim 17 wherein said imaging system is a computed tomography imaging system.

20. The system of claim 17 wherein said imaging system and said processing device are physically located in the same geographic location.

21. The system of claim 17 wherein said imaging system and said processing device are physically located in different geographic locations.

22. The system of claim 17 wherein said processing device is in communication with said imaging system over a network.

23. The system of claim 22 wherein said network is the Internet.

24. A computer program product for calculating mass scores of calcium deposits, the product comprising:
a storage medium readable by a processing circuit and storing instructions for execution by the processing circuit for:
obtaining patient image data;
identifying calcium plaque in said patient image data, wherein said calcium plaque is associated with a plurality of discrete patient pixel elements and wherein each of said patient pixel elements includes a patient pixel value expressed in Hounsfield units;
converting said patient pixel values into patient density values using a calibration curve equation; and
outputting said patient density value.

25. A computer program product for calculating mass scores of calcium deposits, the product comprising:
a storage medium readable by a processing circuit and storing instructions for execution by the processing circuit for:
creating a calibration curve equation, wherein said creating includes:
obtaining phantom image data associated with a plurality of discrete phantom pixel elements corresponding to a calcium insert of known density in a phantom, wherein each of said phantom pixel elements includes a phantom pixel value expressed in Hounsfield units;
graphing said phantom image data against said known density of said calcium insert; and
developing said calibration curve equation for computing said patient density values in response to patient pixel values;
obtaining patient image data;
identifying calcium plaque in said patient image data, wherein said calcium plaque is associated with a plurality of discrete patient pixel elements and wherein each of said patient pixel elements includes a said patient pixel value expressed in Hounsfield units;
converting said patient pixel values into patient density values using said calibration curve equation; and
outputting said patient density values.
